(19) United States
(12) Patent Application Publication
(10) Pub. No.: US 2024/0204600 A1
(43) Pub. Date: Jun. 20, 2024

(54) ROTOR HAVING A SLOT WEDGE, ELECTRIC MACHINE, MOTOR VEHICLE, AND METHOD FOR PRODUCING A ROTOR

(71) Applicant: Vitesco Technologies GmbH, Regensburg (DE)

(72) Inventors: Dominik Grauvogl, Schwandorf (DE); Peter Stauder, Mainz (DE)

(73) Assignee: Vitesco Technologies GmbH, Regensburg (DE)

(21) Appl. No.: 18/415,290

(22) Filed: Jan. 17, 2024

Related U.S. Application Data
(63) Continuation of application No. PCT/EP2022/070470, filed on Jul. 21, 2022.

(30) Foreign Application Priority Data
Jul. 23, 2021 (DE) 10 2021 119 142.4

(51) Int. Cl. H02K 3/487; H02K 1/24; H02K 15/00

(52) U.S. Cl. CPC H02K 3/487; H02K 1/24; H02K 15/0018

(57) ABSTRACT

A rotor for an externally excited electric machine of a motor vehicle, including an annular yoke with a yoke outer side directed outward in the radial direction of the yoke, wherein on the yoke outer side, a plurality of pole teeth are arranged and/or formed spaced apart from one another in the circumferential direction of the yoke, each pole tooth has a pole shaft and a pole shoe, wherein the pole shaft is formed between the yoke outer side and the pole shoe, a rotor winding is arranged on each pole shaft, and a slot wedge is arranged in a slot between the rotor windings of two adjacent pole teeth, wherein on an outer side facing the respective rotor winding, the slot wedge has a layer of an elastomer, against which the rotor winding bears at least partially and/or in portions.

### CROSS-REFERENCE TO RELATED APPLICATIONS

This application claims priority to PCT Application PCT/EP2022/070470, filed Jul. 21, 2022, which claims priority to German Patent Application No. DE 10 2021 119 142.4, filed Jul. 23, 2021. The disclosures of the above applications are incorporated herein by reference.

### FIELD OF THE INVENTION

The invention concerns a rotor for an externally excited electric machine, wherein the rotor has salient poles, known as pole teeth, on which a rotor winding is arranged. A slot wedge is arranged in a slot formed between the rotor windings of two adjacent pole teeth, wherein the slot wedge has a layer of an elastomer on an outer side facing the rotor winding. The invention moreover relates to an electric machine having the rotor according to the invention. The invention also concerns a motor vehicle having the electric machine according to the invention. Moreover, the invention relates to a method for producing the rotor according to the invention.

### BACKGROUND OF THE INVENTION

Rotors for electric machines of motor vehicles, such as axle drives, are known in principle. The rotors may either be permanently excited or externally excited via a winding. Because of the limited availability of rare earths for the magnets of permanently excited rotors, and the increased sales of at least partially electrically driven vehicles, externally excited electric machines are becoming increasingly important. Inter alia, one aspect of production of externally excited motors is the arrangement of the winding on the pole teeth on the rotors. During rotation of the rotor, centrifugal forces act on the winding so that this can shift and in the worst case become detached.

### SUMMARY OF THE INVENTION

It is an object of the invention to provide a rotor for an externally excited electric machine of a motor vehicle in which the rotor winding is fixed carefully and positionally securely on the pole teeth of the rotor.

This object is achieved by the subject described herein. Additional refinements of the invention are the subject of the description which follows and the drawings. Here, each feature described and/or illustrated may represent an aspect of the invention both individually and in combination, provided nothing to the contrary is explicitly stated in the description.

According to first aspect, the invention relates to a rotor for an externally excited electric machine of a motor vehicle, having an annular yoke with a yoke outer side directed outward in the radial direction of the yoke, wherein on the yoke outer side, a plurality of pole teeth are arranged and/or formed spaced apart from one another in the circumferential direction of the yoke, each pole tooth has a pole shaft and a pole shoe, wherein the pole shaft is formed between the yoke outer side and the pole shoe, a rotor winding is arranged on each pole shaft, and a slot wedge is arranged in a slot between the rotor windings of two adjacent pole teeth, wherein on an outer side facing the respective rotor winding, the slot wedge has a layer of an elastomer, against which the rotor winding bears at least partially and/or in portions.

In other words, according to the first aspect of the invention, a rotor is provided for an externally excited electric machine of a motor vehicle. The electric machine in an embodiment is arranged in a traction drive, such as an axle drive of an at least partially electrically driven motor vehicle.

The rotor has an annular yoke. A plurality of pole teeth are arranged on a yoke outer side of the yoke formed in the radial direction of the yoke or rotor. A plurality of pole teeth means at least two pole teeth. However, more than two teeth, an in various embodiments four pole teeth, six pole teeth or eight pole teeth are provided. The pole teeth are arranged and/or formed spaced apart from one another in the circumferential direction of the yoke. Each pole tooth has a pole shaft and a pole shoe adjoining the pole shaft. The pole shaft is formed between the yoke outer side and the pole shoe. An energizable rotor winding is arranged or wound onto each pole shaft. A slot is formed between the rotor windings of two adjacent pole teeth. A slot wedge, which may also be called a spacer, is arranged in this slot. The slot wedge serves to fix the rotor winding arranged on the pole shaft in its position on the pole shaft. A layer of an elastomer is arranged and/or formed on an outer side of the slot wedge facing the rotor winding. The rotor winding is pressed at least partially and/or in portions into this layer of elastomer, so that a toothed engagement is created between the slot wedge or elastomer layer of the slot wedge and the rotor winding. In this way, the positional fixing of the rotor winding is improved. Also, contact-induced damage between the slot wedge and the rotor winding is reduced because of the elastomer layer, so that the rotor winding may be safely positionally fixed on the pole teeth.

In a refinement of the invention, the elastomer is a rubber material and/or includes rubber at least in parts. The rubber may be a natural rubber or a synthetic rubber. Rubber is a raw material for elastic materials and/or elastic substances which may have rubber-like properties.

In this context, in an embodiment of the invention, the rubber material is an ethylene propylene diene rubber (EPDM) or a butyl rubber (IIR). Ethylene propylene diene rubbers and butyl rubbers have an increased temperature resistance, which is advantageous in the use of electric machines since they may be exposed to high temperatures during operation. Also, the elastomer layer, including for example ethylene propylene diene rubber, may be vulcanized and/or glued onto the slot wedge.

In a refinement of the invention, the slot wedge has a triangular and/or wedge-shaped base form in cross-section, wherein a tip of the wedge-shaped slot wedge points in the direction of the yoke outer side, a closed-edge opening runs through the slot wedge in the longitudinal direction of the rotor, and the opening is filled with an expandable material at least in portions. The slot wedge thus has wedge legs between the opening and the slot outer side. Because the opening, which has closed edges in cross-section, is filled with expandable material, the wedge legs are deformed in the direction of the rotor winding, whereby the elastomer layer is pressed against the rotor winding. Thus for example the slot wedge may be arranged in the slot between the rotor windings of adjacent pole teeth with a degree of play, which may further reduce damage to the rotor winding from insertion of the slot wedge into the slot.

An embodiment of the invention is that the slot wedge is made of plastic. Slot wedges made of plastic may be produced cheaply and have a reduced weight. The plastic may be a thermoplastic or a duroplastic material. In an embodiment, it may be provided that the plastic is reinforced with fibres, such as carbon fibres and/or glass fibres, at least in parts and/or in portions. In this way, the structural stiffness of the slot wedge is increased in targeted fashion and the weight of the slot wedge or rotor is reduced.

In an embodiment of the invention, the opening in the cross-section of the slot wedge has a substantially triangular form. Substantially means that the cross-sectional area of the opening corresponds approximately to the outer contour of the slot wedge in its cross-section, wherein the corners however are rounded. The opening is surrounded by an inner wall face of the slot wedge. In the region of the wedge legs, the inner wall face runs parallel to the outer side at least in portions. Thus the geometry of the opening and also the wall thickness of the wedge legs allow targeted formation of the regions which are deformed outward because of the material introduced into the opening, so as to press the elastomer layer onto the rotor winding.

In a refinement of the invention, it is provided that a slot wedge end of the slot wedge rests at least in portions against a pole shoe inner face. In an embodiment, the slot wedge is inserted in the slot between the pole teeth in the longitudinal direction of the rotor. This may prevent the slot wedge from slipping out of the slot in the radial direction of the rotor under the effect of centrifugal force.

In an embodiment, it is furthermore provided that the slot wedge has a widening on the side facing the yoke outer side, which at least in portions engages behind the inner side of the rotor winding facing the yoke outer side. Because the slot wedge presses the rotor winding onto the pole shaft and the rotor winding is thus held immovably on the pole shaft, and the widening of the slot wedge engages behind the inner side of the rotor winding, the slot wedge is fixed in the slot in self-locking fashion.

In principle, the expandable material may be a material which is designed to be introduced into the opening of the slot wedge, to increase its own volume, harden and become temperature-resistant and form-stable. For this, it is provided that the expandable material is a polymer and/or a plastic and/or a synthetic resin, such as a polyurethane foam.

In a second aspect, the invention relates to an electric machine with the rotor according to the invention.

The electric machine is configured and/or designed to be arranged and operated in a motor vehicle, such as in a traction drive of an at least partially electrically driven motor vehicle.

In a third aspect, the invention relates to a motor vehicle with the electric machine according to the invention.

The motor vehicle is an at least partially electrically driven motor vehicle. The motor vehicle has a traction drive, an in an embodiment is an axle drive. The electric machine is part of the traction drive, via which the motor vehicle may be driven.

In a fourth aspect, the invention relates to a method for producing the rotor according to the invention, having the steps:
provision of a rotor with a plurality of pole teeth spaced apart from one another;
arrangement of an energizable rotor winding on the respective pole teeth;
insertion of a slot wedge in a slot between the rotor windings of two adjacent pole teeth, wherein the slot wedge has a layer of an elastomer on an outer side facing the respective rotor winding, and the rotor winding is pressed into the elastomer layer at least in part and/or in portions.

Accordingly, it is provided that the rotor winding arranged on the pole shaft is fixed positionally securely via the slot wedge and the elastomer layer arranged on the slot wedge.

The elastomer layer may be vulcanized, sprayed, laminated and/or glued onto the outer side of the slot wedge so that it is captively connected to the slot wedge. Therefore, when the slot wedge is inserted in the slot, the position of the elastomer layer need not be checked further.

In an embodiment, the slot wedge is inserted in the slot between the pole teeth in the longitudinal direction of the rotor. In this way, the slot wedge is safely positioned.

In a refinement of the invention, after insertion of the slot wedge into the slot, an opening of the slot wedge running in the longitudinal direction is filled with an expandable material. The wedge legs are deformed or pressed outward at least in portions by the expandable material so that the elastomer layer is pressed against the rotor winding.

In an embodiment of the invention, it may be provided that before the slot wedge is arranged in the slot, the expandable material is already arranged in the opening and is only activated after the slot wedge has been inserted in the slot, whereby the expandable material increases in volume and expands in the opening. This may be advantageous for the production process since the slot wedge may be prepared accordingly outside the rotor.

Alternatively, an embodiment of the invention provides that the opening is filled with expandable material after the slot wedge has been inserted in the slot.

It is pointed out that all features described above and below in reference to an aspect of the present invention apply equally to any other aspect of the present invention. In various embodiments, all features of the rotor may also be features of the electric drive, features of the motor vehicle and/or also features of the method. This also applies conversely.

Further features and advantages of the present invention will emerge from the following exemplary embodiments. The exemplary embodiments are to be understood not as restrictive, but rather as examples. They are intended to enable a person skilled in the art to implement the invention. The applicant reserves the right to make one and/or more of the features disclosed in the exemplary embodiments. The exemplary embodiments will be discussed in more detail with reference to drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the drawings:

FIG. 1 shows a cross-section through a rotor in the region of two pole teeth,

FIG. 2 shows a motor vehicle with an electric machine,

FIG. 3 shows a method for producing a rotor.

### DETAILED DESCRIPTION OF THE PREFERRED EMBODIMENTS

The following description of the preferred embodiment(s) is merely exemplary in nature and is in no way intended to limit the invention, its application, or uses.

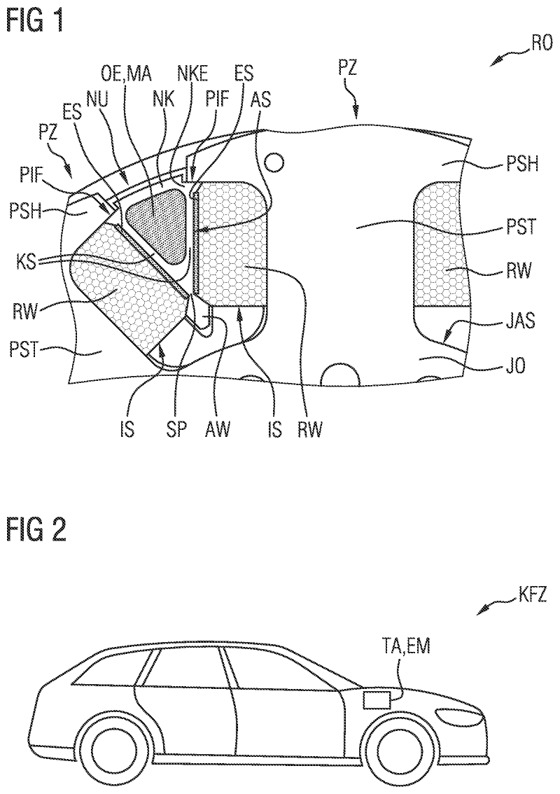

FIG. 1 shows a cross-section through a rotor RO of an externally excited electric machine EM for a motor vehicle KFZ. The rotor RO has an annular yoke JO. A plurality of pole teeth PZ is arranged on a yoke outer side JAS of the yoke JO formed in the radial direction of the yoke JO or rotor RO. The pole teeth PZ are arranged and/or formed spaced apart from one another in the circumferential direction of the yoke JO.

Each pole tooth PZ has a pole shaft PST and a pole shoe PSH adjoining the pole shaft PST. The pole shaft PST is formed between the yoke outer side JAS and the pole shoe PSH. An energizable rotor winding RW is arranged or wound onto each pole shaft PST.

A slot NU is formed between the rotor windings RW of two adjacent pole teeth. A slot wedge NK, which may also be called a spacer, is arranged in this slot NU. The slot wedge NK serves to fix the rotor winding RW arranged on the pole shaft PST in its position on the pole shaft PST. A layer ES of an elastomer is arranged and/or formed on an outer side AS of the slot wedge NK facing the rotor winding RW. The rotor winding RW is pressed at least partially and/or in portions into this elastomer layer ES, so that a toothed engagement is created between the slot wedge NK or elastomer layer ES of the slot wedge NK and the rotor winding RW. In this way, the positional fixing of the rotor winding RW is improved. Also, contact-induced damage between the slot wedge NK and the rotor winding RW is reduced because of the elastomer layer ES, so that the rotor winding RW may be safely positionally fixed on the pole teeth PZ.

It is furthermore clear that the slot wedge NK has a base form of triangular and/or wedge-shaped cross-section, wherein the tip SP of the wedge-shaped slot wedge NK points in the direction of the yoke outer side JAS. An opening OE with closed edges runs through the slot wedge NK in its longitudinal direction, and is filled at least in portions with an expandable material EM. The slot wedge NK thus has wedge legs KS between the opening OE and the outer side AS of the slot wedge NK. Because the opening OE, which has closed edges in cross-section, is filled with expandable material MA, the wedge legs KS are deformed in the direction of the rotor winding RW at least in portions, whereby the elastomer layer ES is pressed against the rotor winding RW. Thus for example the slot wedge NK may be arranged in the slot NU between the rotor windings RW of two adjacent pole teeth PZ with a degree of play, which may further reduce damage to the rotor winding RW from insertion of the slot wedge NK into the slot NU. Also, because of the clamping of the slot wedge NK on the rotor winding RW, the rotor winding RW need not be encapsulated with a casting material. The rotor winding RW may thus be arranged on the pole shaft PST without casting.

The slot wedge NK has a widening AW on the side facing the yoke outer side JAS, which at least in portions engages behind an inner side IS of the rotor winding RW facing the yoke outer side JAS. Because the slot wedge NK presses the rotor winding RW onto the pole shaft PST and the rotor winding RW is thus held immovably on the pole shaft PST, and the widening AW of the slot wedge NK engages behind the inner side IS of the rotor winding RW, the slot wedge NK is fixed in the slot NU in self-locking fashion.

Furthermore, it is clear that a slot wedge end NKE of the slot wedge NK bears at least in portions against a pole shoe inner face PIF. The slot wedge end NKE is arranged on a side facing away from the tip SP of the slot wedge NK, i.e. directed outward in the radial direction of the yoke JO. A maximum width of the slot wedge NK in the circumferential direction of the yoke JO is wider than the smallest distance between two adjacent pole shoes PSH. This prevents the slot wedge NK from slipping out of the slot NU in the radial direction of the rotor RO under the effect of centrifugal force.

FIG. 2 shows a motor vehicle KFZ with a drive device, such as a traction drive TA. The traction drive TA includes the externally excited electric machine EM. The rotor RO known from FIG. 1 is arranged in the electric machine EM.

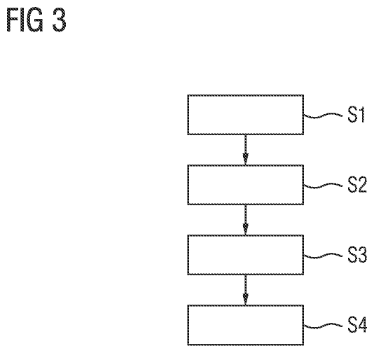

FIG. 3 shows a method for producing a rotor RO.

In a first step S1, the rotor RO is provided with a plurality of pole teeth PZ spaced apart from one another.

In a second step S2, an energizable rotor winding RW is wound onto the respective pole teeth PZ.

In a third step S3, the slot wedge NK is arranged in a slot NU between the rotor windings RW of two adjacent pole teeth PZ. The slot wedge NK is arranged in the slot NU in a direction parallel to the longitudinal direction of the rotor RO. In other words, the slot wedge NK is inserted into the slot NU in the longitudinal direction of the rotor RO. On an outer side AS facing the respective rotor winding RW, the slot wedge NK has a layer ES of an elastomer.

In a fourth step S4, it is provided that after insertion of the slot wedge NK into the slot NU, an opening OE of the slot wedge NK running in the longitudinal direction is filled with an expandable material MA. The wedge legs KS of the slot wedge NK are deformed or pressed outward at least in portions by the expandable material MA so that the elastomer layer ES is pressed against the rotor winding RW.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A rotor for an externally excited electric machine of a motor vehicle, comprising:
an annular yoke with a yoke outer side directed outward in the radial direction of the yoke;
a plurality of pole teeth on the yoke outer side, the plurality of pole teeth are arranged and/or formed spaced apart from one another in the circumferential direction of the yoke, each of the plurality of pole teeth further comprising:
a pole shaft; and
a pole shoe;
wherein the pole shaft is formed between the yoke outer side and the pole shoe;
a rotor winding arranged on each pole shaft;
a slot wedge arranged in a slot between the rotor windings of two adjacent pole teeth; and
a layer of an elastomer on an outer side of the slot wedge, the layer of elastomer facing the respective rotor winding, against which the rotor winding bears at least partially and/or in portions.

2. The rotor of claim 1, the elastomer further comprising a rubber material and/or comprises rubber at least in parts.

3. The rotor of claim 1, the rubber material further comprising an ethylene propylene diene rubber (EPDM) or a butyl rubber (IIR).

4. The rotor of claim 1, the slot wedge further comprising:
a triangular and/or wedge-shaped base form in cross-section, and a tip of the wedge-shaped slot wedge points in the direction of the yoke outer side; and
a closed-edge opening which runs through the slot wedge in the longitudinal direction of the rotor, and the opening is filled with an expandable material at least in portions.

5. The rotor of claim 4, the closed-edge opening further comprising a substantially triangular cross-section.

6. The rotor of claim 1, wherein the slot wedge is made of plastic.

7. The rotor of claim 1, the slot wedge further comprising a slot wedge end, wherein the slot wedge end bears at least in portions against a pole shoe inner face.

8. The rotor of claim 1, wherein the slot wedge has a widening on the side facing the yoke outer side, which at least in portions engages behind the inner side of the rotor winding facing the yoke outer side.

9. The rotor of claim 4, the expandable material further comprising one selected from the group consisting of a polymer and/or a plastic and/or a synthetic resin.

10. The rotor of claim 4, the expandable material further comprising a polyurethane foam.

11. An electric machine with a rotor of claim 1.

12. A motor vehicle having an electric machine of claim 11.

13. A method for producing a rotor, comprising the steps of:
providing a rotor with a plurality of pole teeth spaced apart from one another;
arranging an energizable rotor winding on a corresponding one of the plurality of pole teeth;
inserting a slot wedge in a slot between the rotor windings of two adjacent pole teeth, wherein the slot wedge has a layer of an elastomer on an outer side facing the respective rotor winding, and the rotor winding is pressed into the elastomer layer at least in part and/or in portions.

14. The method of claim 13, further comprising the steps of, after insertion of the slot wedge into the slot, filling an opening of the slot wedge running in the longitudinal direction with an expandable material.

15. The method of claim 13, further comprising the steps of:
arranging the expandable material in the opening before the slot wedge is arranged in the slot; and
activating the expandable material only after the slot wedge has been inserted in the slot, such that the expandable material increases in volume and expands in the opening.

16. The method of claim 13, further comprising the steps of, after insertion of the slot wedge into the slot, filling the opening with an expandable material.
